(19) United States
(12) Patent Application Publication
(10) Pub. No.: US 2006/0224568 A1
(43) Pub. Date: Oct. 5, 2006

(54) Automatically displaying fields that were non-displayed when the fields are filter fields

(76) Inventor: Daniel N. Debrito, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/097,540

(22) Filed: Apr. 2, 2005

(51) Int. Cl. G06F 17/30

(52) U.S. Cl. 707/3

(57) ABSTRACT

A number of records are displayed. Each record has one or more values for a number of fields. The fields includes one or more non-displayed fields. The values of each record for each non-display field are not displayed. The records are filtered by one or more selected values for each of one or more filter fields to yield one or more result records. Each of at least one of the filter beings is one of the non-displayed fields. The one or more result records are displayed. The values of each result record for each filter field are displayed, such that at least one of the non-displayed fields is displayed automatically without user instruction to be displayed.

### BACKGROUND

A common use of computers and other computing systems is the storage, manipulation, and display of data. Many types of data are organized as a number of records, with each record having one or more values for each of a number of different fields. For example, the records may correspond to employees, with the fields including employee first name, employee last name, years with the company, manager, department, title, salary, and so on.

Sometimes there are a large number of fields for each record, such that not all of the fields are displayed when displaying the records. In the previous example, the years with the company field may not be displayed, for instance. When such non-displayed fields are subsequently used to filter the data to yield result records matching the filtering, or searching, criteria, the resulting display of the result records may still not show the values of the records for such fields.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of an example table of data, in conjunction with which embodiments of the invention may be practiced.

FIG. 2 is a diagram of an example view of data, in which record values are not shown for all fields of the data, according to an embodiment of the invention.

FIG. 3 is a diagram of an example window in which the user may filter the data by defining filtering criteria, according to an embodiment of the invention.

FIG. 4 is a diagram of an example view of data in which the result records yielded after filtering the data are displayed, and in which previously non-displayed fields are automatically displayed if they are filter fields, according to an embodiment of the invention.

FIG. 5 is a diagram of a window serving as the customization edit screen, in which a user may select which fields are to be displayed, according to an embodiment of the invention.

FIG. 6 is a flowchart of a method, according to an embodiment of the invention.

FIG. 7 is a block diagram of a computer system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

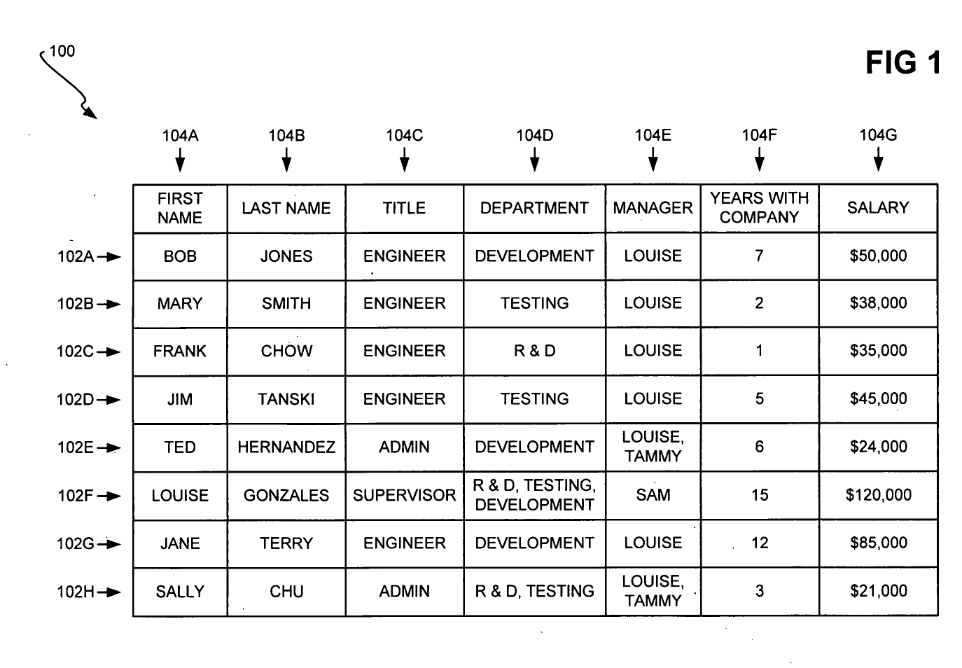

FIG. 1 shows an example table of data 100, in conjunction with which embodiments of the invention may be practiced. The data 100 includes a number of records 102A, 102B, 102C, 102D, 102E, 102F, 102G, and 102H, collectively referred to as the records 102. The records 102 each have one or more values for each of a number of fields 104A, 104B, 104C, 104D, 104E, 104F, and 104G, collectively referred to as the fields 104. As depicted in FIG. 1, the data 100 may be organized as a number of rows corresponding to the records 102 and a number of columns corresponding to the fields 104. Although eight records 102 and seven fields 104 are depicted in FIG. 1, such a limited number of records and fields is presented in the example of FIG. 1 for illustrative convenience. In general, there can be many more records and/or fields.

Each of the records 102 is shown in FIG. 1 as having one or more values for each of the fields 104. In another embodiment, one or more of the records 102 may not have a specified value for one or more of the fields 104. For example, one or more of the records 102 may not have a specified value for the field 104F, corresponding to years with the company, if such information is unavailable. In such instance, it is said that the records in question have empty values for such fields, although a record having an empty value for any field is still encompassed under the language that the record has a value for that field. That is, that a record has a value for a given field can include the record having an empty value for that field.

Some of the fields 104 are multi-valued fields, such that the records 102 are able to have one or more values for these fields. For example, the fields 104D and 104E are multi-valued fields. In the example of FIG. 1, the record 102E has two values for the field 104E, “Louise” and “Tammy,” and the record 102F has three values for the field 104D, “R&D,” “Testing,” and “Development.” Furthermore, the record 102H has two values for the field 104D, “R&D” and “Testing,” and has two values for the field 104E, “Louise” and “Tammy.”

The data 100 of FIG. 1 is used herein to describe embodiments of the invention. However, embodiments of the invention are not limited to implementation in relation to the data 100, nor to the type of the data 100. For example, as can be gleaned from FIG. 1, the data 100 is concerned with employee records, and stores information regarding employees, such as first name, last name, title, department, manager, years with the company, and salary. Embodiments of the invention are not limited to implementation in relation to such employee-oriented data.

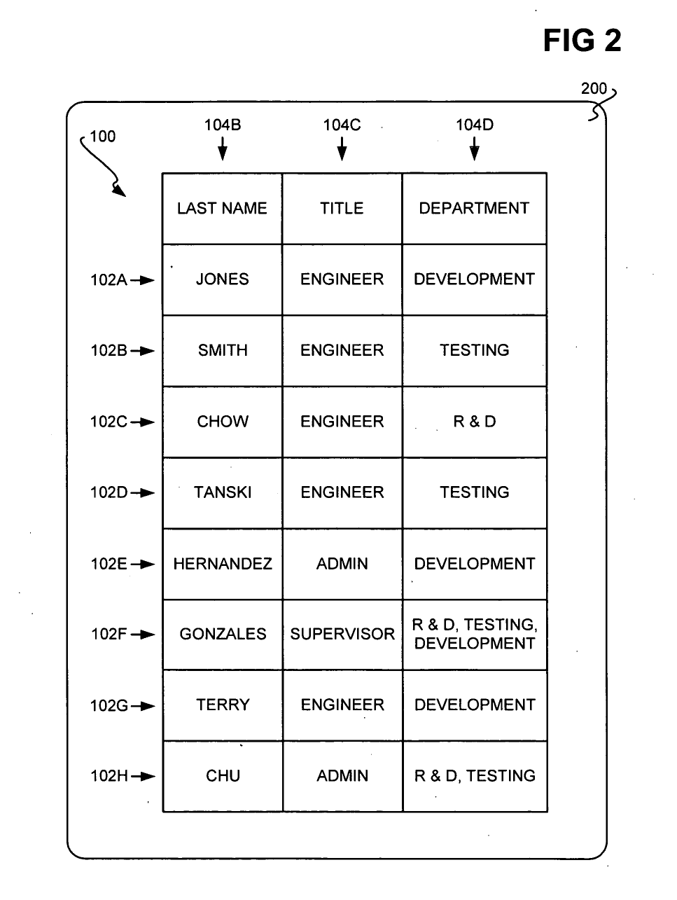

FIG. 2 shows an example view 200 of the data 100 in which the values of the records 102 are not shown for all of the fields 104, according to an embodiment of the invention. In particular, the values of the records 102 are shown in the view 200 just for the fields 104B, 104C, and 104D. In the example of FIG. 2, the fields 104B, 104C, and 104D are referred to as displayed fields. The other fields 104A, 104E, 104F, and 104G, for which the values of the records 102 are not shown in the view 200, are referred to as non-displayed fields.

The user viewing the data 100 may have selected that just the values of the records 102 be displayed for the fields 104B, 104C, and 104D, and not for the other fields, for instance, to concentrate on the information presented in the fields 104B, 104C, and 104D. The displayed fields and the non-displayed fields can be dynamic. This means that the user may be able to select at any given time which fields are displayed within a given view, and which fields are not displayed within a given view.

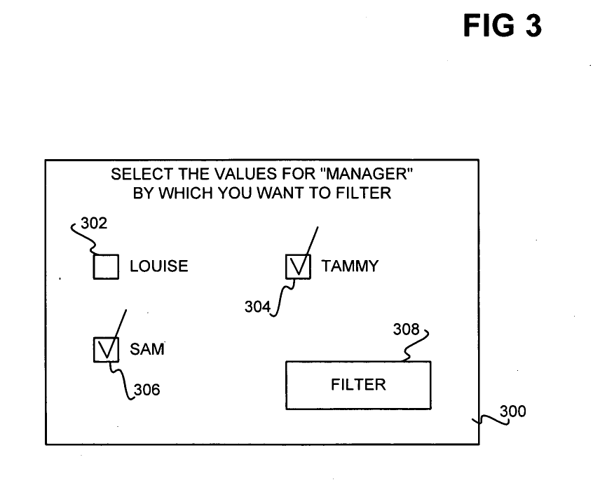

FIG. 3 shows an example window 300 that may be displayed when the user wishes to filter the data 100 so that only the records 102 matching the filtering criteria are subsequently displayed, according to an embodiment of the invention. For example, the user may have been viewing the data 100 in accordance with the view 200 of FIG. 2. The user may then have decided to filter the data 100 so that only those of the records 102 that have certain selected values for the non-displayed field 104E, corresponding to manager, be displayed.

As such, the window 300 may be displayed, in which the user is requested to select the values for the manager field 104E by which to filter the data 100. Therefore, there are checkboxes 302, 304, and 306 for all three different data values that any of the records 102 has for the field 104E: “Louise,” “Tammy,” and “Sam.” In the example of FIG. 3, the user has selected to filter the data 100 by the data values “Tammy” and “Sam” for the non-displayed manager field 104E. Thus, the user wishes to see all of the records 102 that have the value “Tammy”or the value “Sam” in the field 104E. Once the user has made his or her selections, the filter button 308 is selected to filter the data 100 and display the results.

These selected data values for the field 104E constitute the filtering criteria in the example of FIG. 3. The field 104E is considered a filter field, in that it is the field for which the user has selected values in order to filter the data 100. There may be more than one filter field, as can be appreciated by those of ordinary skill within the art. Embodiments of the invention are relevant where at least one of the filter fields is a non-displayed field—that is, when at least one of the filter fields is a field that is not currently being displayed in the view desired by the user, such as the view 200 of FIG. 2.

Furthermore, the filtering that may be accomplished is not restricted by embodiments of the invention. For example, the filtering in the example of FIG. 3 is such that a record having either the value “Tammy” or the value “Sam” in the field 104E will be displayed. Such filtering is a logical OR-type filtering. In another embodiment, the filtering may be accomplished such that a record has to have both the selected values in the field 104E, such as both the value “Tammy” and the value “Sam,” in order to be displayed. This type of filtering is a logical AND-type filtering. Other types of Boolean logic and non-Boolean logic filtering may also be employed.

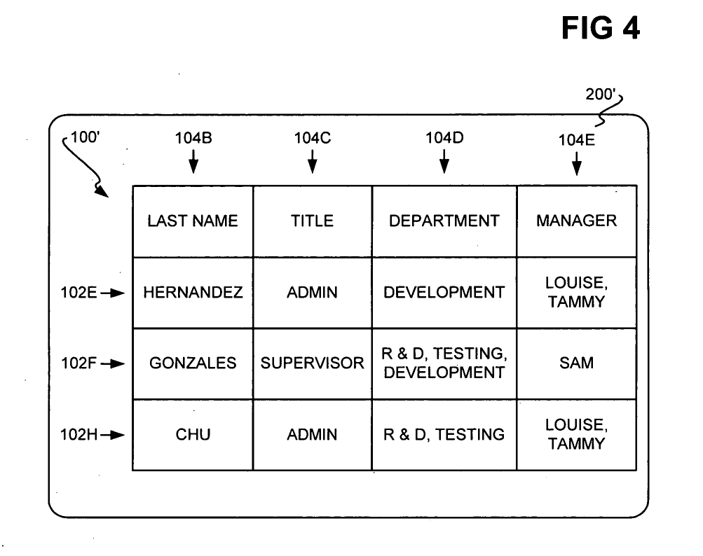

FIG. 4 shows the view 200 of FIG. 2, as the view 200′, in which the results of the filtering of FIG. 3 are displayed, according to an embodiment of the invention. The data 100 is denoted as the data 100′ because just a subset of the data 100 is depicted in FIG. 4, specifically the records 102E, 102F, and 102H. The records 102E, 102F, and 102H are the records that are yielded from the filtering of FIG. 3. That is, each of the records 102E, 102F, and 102H has the value “Tammy” or “Sam” for the field 104E. The records 102E, 102F, and 102H are referred to as the result records that are yielded after filtering.

The view 200 of FIG. 2 is denoted as the view 200′ because the values of the records 102E, 102F, and 102H are depicted for the field 104E, which was previously a non-displayed field in the view 200 of FIG. 2, in addition to the values of these records for the fields 104B, 104C, and 104D being depicted, as before. That is, after filtering, the previous view 200 of the data 100 is used to depict the data 100′ including just the result records that match the filtering criteria. Thus, the values of the records 102E, 102F, and 102H, are displayed for the displayed fields 104B, 104C, and 104D, but not for the non-displayed fields 104F and 104G.

However, the values of the records 102E, 102F, and 102H are also automatically displayed for the non-displayed field 104E in the view 200′, even though the field 104E was not displayed in the view 200. This is because the non-displayed field 104E was a filter field. In general, any non-displayed field that is a filter field is automatically displayed when the result records of that filtering are displayed, without requiring user instruction to be displayed.

Automatically displaying the values of the result records for non-displayed fields that are filter fields is advantageous, as is now described. In the filtering of FIG. 3, the user has indicated his or her desire to see those records having the value “Sam” or “Tammy” within the filter field 104E, corresponding to manager. If in FIG. 4 the values of the result records 102E, 102F, and 102H for the manager field 104E were not displayed, the user would have no way of knowing whether a given record has the value “Sam,” the value “Tammy,” or both the values “Sam” and “Tammy” for the field 104E. By automatically displaying the values of the result records 102E, 102F, and 102H for the non-displayed field 104E, the embodiment of FIG. 4 allows the user to easily see that the records 102E and 102H has the value “Tammy” (as well as the value “Louise”) for the field 104E, and that the record 102F has the value “Sam” for the field 104E.

In different embodiments of the invention, the automatic display of the values of the result records for non-displayed fields that are filter fields is accomplished in accordance with certain constraints. For example, the values of the result records for a non-displayed filter field may be displayed only if two or more different values are selected as the filtering criteria for this field. Using the example of FIG. 3, for instance, the user may have decided to see the records 102 that just have the value “Louise” for the manager field 104E. In such instance, the filter field 104E may not automatically be displayed in the resulting view 200′ of FIG. 4, because the user would inherently know that each of the result records shown as part of the data 100′ has the value “Louise” for the field 104E. By comparison, where the user decides to see the records 102 that have either the value “Tammy” or the value “Sam” for the manager field 104E, if the filter field 104E were not automatically displayed in the resulting view 200′, then the user would not be able to discern which of the result records have the value “Tammy” and which have the value “Louise” for the field 304E.

Furthermore, in one embodiment, the user may be able to provide instruction so that the automatically displayed filter fields that were previously not displayed are again not displayed. In the case of FIG. 4, for instance, providing such user instruction would mean that the values of the result records 102E, 102F, and 102H for the manager field 104E are no longer displayed. The type of user instruction is not limited by embodiments of the invention. The user instruction may include the user selecting a button, which is not specifically shown in FIG. 4. Furthermore, the user instruction may include the user opening a customization edit screen in which to define the current view, as is now described.

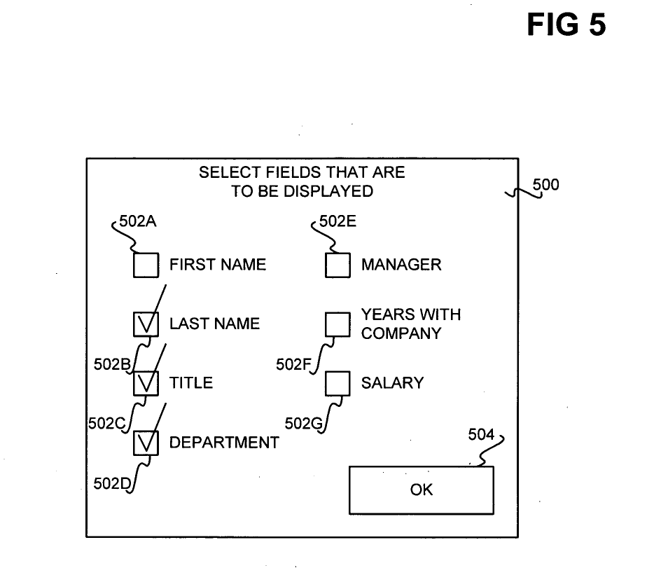

FIG. 5 shows an example window 500 that may be displayed when the user wishes to define the current view, as the customization edit screen, according to an embodiment of the invention. For example purposes, it is presumed that the user was viewing the result records 102E, 102F, and 102H within the view 200′ of FIG. 4, and has decided to redefine the current view 200′. As a result, the window 500 is displayed, as the customization edit screen, for this purpose.

The user is requested in the window 500 to select those of the fields 104 for which he or she wishes to view the values of the result records 102E, 102F, and 102H. There are checkboxes 502A, 502B, 502C, 502D, 502E, 502F, and 502G, collectively referred to as the checkboxes 502, and corresponding to the fields 104. The checkboxes 502B, 502C, and 502D are preselected for the user, because their corresponding fields 104B, 104C, and 104D are the displayed fields within the view 200 of FIG. 2 and the view 200′ of FIG. 4.

However, the checkbox 502E is not preselected for the user, even though the corresponding field 104E is displayed in the view 200′ of FIG. 4. This is because the field 104E is not a displayed field, in that it was not displayed within the view 200 of FIG. 2, and thus may not have been previously selected by the user for display. Rather, the field 104E was a non-displayed field in FIG. 2, and is displayed within the view 200′ of FIG. 4 just because the field 104E is a filter field, and thus is automatically displayed.

In other words, non-displayed fields that are automatically displayed as a result of their being filter fields are not preselected for the user within the customization edit screen. Rather, just the displayed fields are automatically preselected for the user within the customization edit screen. As such, the user can cause the customization edit screen, such as the window 500, to be displayed, and then can immediately select the OK button 504, to cause the previous view 200 of FIG. 2 to again be displayed (albeit with just the result records 102E, 104F, and 102H being shown), instead of the view 200′ of FIG. 4, which includes the filter field 104E.

The user may also change the current view by appropriately selecting and deselecting the checkboxes within the window 500 of FIG. 5. For example, the user may decide not to view the values of the result records 102E, 102F, and 102H for the department field 102D, and thus may deselect the checkbox 502D. Conversely, the user may decide to view the values of the result records 102E, 102F, and 102H for the first name field 102A, and thus may select the checkbox 502A. Once the user is satisfied with his or her changes, the OK button 504 is selected to cause the data to again be displayed.

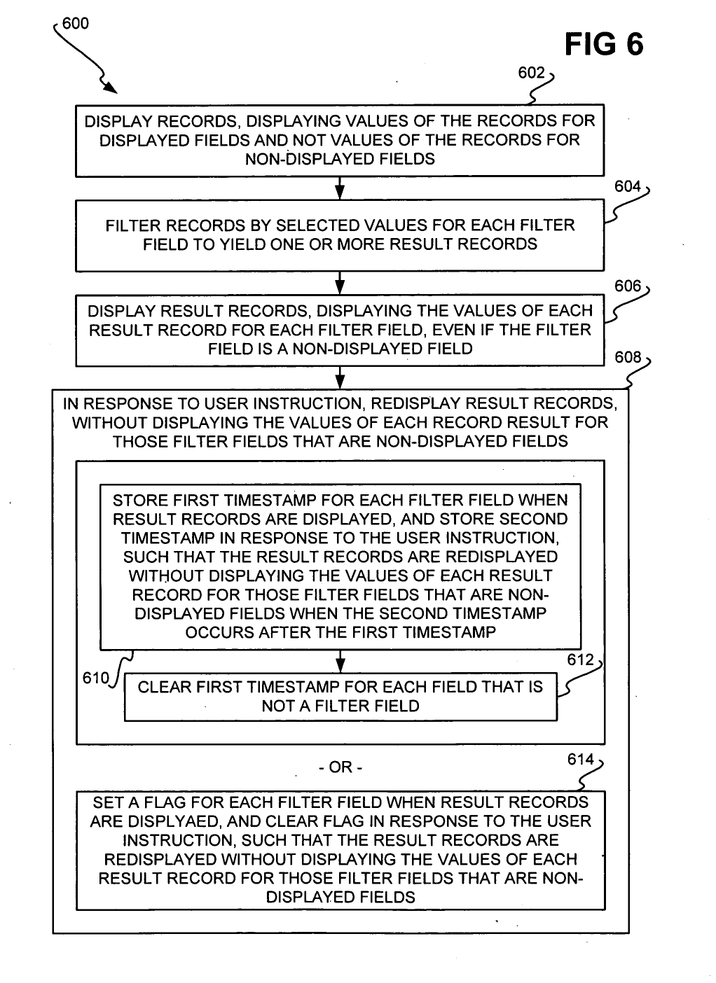

FIG. 6 shows a method 600 for displaying the data 100, for filtering the data 100, and for displaying the results of filtering the data 100, according to an embodiment of the invention. The method 600 can be used to result in the display of the data 100 as has been described in relation to FIGS. 2 and 4, in-between which the data 100 was filtered as has been described in relation to FIG. 3. At least some parts of the method 600 may be implemented as one or more computer program parts of a computer program stored on a computer-readable medium. The medium may be a volatile or a non-volatile medium, and also may be a magnetic medium, an optical medium, and/or a semiconductor medium. The computer program parts may each be a subroutine, a section, an object, or another type of computer program part.

The records 102 of the data 100 are initially displayed (602), including displaying the values of the records 102 for each of the fields 104 that is a displayed field, and not displaying the values of the records 102 for each of the fields 104 that is a non-displayed field. An example of such display is shown in and has been described in relation to FIG. 2. Where the data 100 is a table of data, the data 100 may be displayed in 602 as a number of rows and a number of columns. The records 102 may correspond to the rows, and the fields 104 may correspond to the columns. In such instance, the number of fields 104 is greater than the number of columns, where at least one of the fields 104 is a non-displayed field and thus is not displayed.

The records 102 are then filtered by one or more selected values for each of one or more filter fields, to yield one or more result records (604). An example of such filtering is shown in and has been described in relation to FIG. 3. Each of the filter fields is one of the non-displayed fields, for purposes of subsequent performance of the method 600.

Next, the result records are displayed (606), including displaying the values of each result record for each filter field (given one or more constraints in one embodiment), even if the filter field is a non-displayed field, without direct user instruction to be displayed. An example of such display is shown in and has been described in relation to FIG. 4. An example of a constraint is that the values of the result records for a filter field that is a non-displayed field are displayed where the number of selected values for the filter field is greater than one, as has been described. Where the data 100 is a table of data, the result records may be redisplayed in 608 as rows, and the fields 104 as columns, such that the values of the result records for each field that is a filter field and a previously non-displayed field are now automatically displayed, without direct user instruction to be displayed.

In response to some type of user instruction, the result records may be redisplayed (608), without displaying the values of each result record for those filter fields that are non-displayed fields. An example of such a redisplay has been described in relation to FIG. 5. One type of user instruction is the opening by the user of a customization edit screen, as is shown in and has been described in relation to FIG. 5.

Two different approaches for implementing the redisplay of the result records in 608 are depicted in FIG. 6, although embodiments of the invention are not limited to any particular implementation approach. In the first approach, a first timestamp is stored for each filter field when the result records are displayed, and a second timestamp is stored in response to the user instruction to redisplay the result records (610). As such, the result records are redisplayed without displaying the values of the result records for each filter field that is one of the non-displayed fields when the second timestamp occurs after the first timestamp for that filter field. Furthermore, in subsequent filtering, the first timestamp is cleared for each field that is not, or no longer, a filter field (612). Thus, in this approach, timestamps are used to denote when result record values have been displayed for filter fields that are non-displayed fields, and when the user has provided some instruction to redisplay those result records. The timestamps are compared to determine whether to redisplay the result records without displaying their values for filter fields that are non-displayed fields.

In the second approach, a flag is set for each filter field when the result records are displayed, and the flag is cleared in response to the user instruction (614). As such, the result records are redisplayed without displaying the values of the result records for each filter field that is one of the non-displayed fields. Thus, in this approach, flags are used to denote when the result record values have been displayed for filter fields that are non-displayed fields. The flags are subsequently cleared when the result records values are no longer displayed for filter fields that are non-displayed fields.

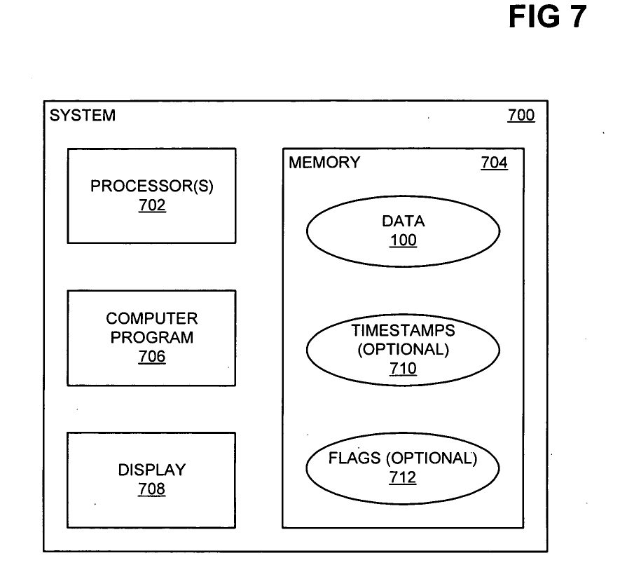

FIG. 7 shows a computer system 700, according to an embodiment of the invention. The computer system 700 may be one or more computing devices, such as one or more computers. The system 700 is depicted in FIG. 7 as including one or more processors 702, memory 704, a computer program 706, and a display 708. The memory 704 is more generally a computer-readable medium, whereas the display 708 may be a cathode-ray tube (CRT) display, a flat panel display, or another type of display. As can be appreciated by those of ordinary skill within the art, the system 700 can and typically will include other components, in addition to and/or in lieu of those depicted in FIG. 7.

The memory 704 stores the data 100 that has been described. The memory 704 may also store timestamps 710, as the timestamps that have been described in relation to the method 600 of FIG. 6, or flags 712, as the flags that have been described in relation to the method 600 of FIG. 6. The computer program 706 is executed by the processors 702. The computer program 706 is to cause the display and redisplay of the data 100 on the display 708, as has been described. The computer program 706 is further to cause the data 100 to be filtered, as has also been described. Thus, the computer program 706 performs the functionality that has been described in relation to and summarized in the method 600 of FIG. 6.

Therefore, it is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of the disclosed embodiments of the present invention. Therefore, it is manifestly intended that this invention be limited only by the claims and equivalents thereof.

I claim:

1. A method comprising:
displaying a plurality of records, each record having one or more values for a plurality of fields, the plurality of fields including one or more non-displayed fields, the values of each record for each non-displayed field not being displayed;
filtering the records by one or more selected values for each of one or more filter fields to yield one or more result records, each of at least one of the filter fields being one of the non-displayed fields; and,
displaying the one or more result records, including displaying the values of each result record for each filter field, such that at least one of the non-displayed fields is displayed automatically without user instruction to be displayed.

2. The method of claim 1, wherein the plurality of fields further includes one or more displayed fields, such the displaying the plurality of records includes displaying the values of each record for each displayed field, and wherein displaying the one or more result records includes displaying the values of each result record for each displayed field.

3. The method of claim 1, wherein the values of each result record for each filter field are displayed where a number of the selected values for the filter field that is one of the non-displayed fields is greater than one.

4. The method of claim 1, further comprising, in response to user instruction, redisplaying the one or more result records without displaying the values of each result record for each filter field that is one of the non-displayed fields.

5. The method of claim 4, wherein the user instruction comprises a user opening a customization edit screen to select which of the fields are to be displayed when displaying the records.

6. The method of claim 5, further comprising, storing a first timestamp for each filter field when the one or more result records are displayed, and storing a second timestamp when the user opens the customization edit screen, such that the one or more result records are redisplayed without displaying the values of each result record for each filter field that is one of the non-displayed fields when the second timestamp occurs after the first timestamp for the filter field.

7. The method of claim 6, further comprising, clearing the first timestamp for each field that is not one of the filter fields.

8. The method of claim 5, further comprising, setting a flag for each filter field when the one or more result records are displayed indicating that the filter field is to be displayed, such that the user opening the customization edit screen causes the flag for each filter field that is one of the non-displayed items to be cleared, resulting in the one or more result records being redisplayed without displaying the values of each result record for each filter field that is one of the non-displayed fields.

9. A method comprising:
displaying a table of data as a plurality of rows and a plurality of columns, the table of data having a plurality of records, each record having one or more values for each of at least one of a plurality of fields of the table of data, each row corresponding to a record of the table of data and each column corresponding to a field of the table of data, the plurality of fields greater in number than the plurality of columns such that at least one of the plurality of fields is not displayed;
filtering the table of data by one or more selected values for each of at least one of the plurality of fields that are not displayed, to yield one or more result records; and,
redisplaying the table of data as the plurality of rows and the plurality of columns such that the values of the result records for each field that was filtered are now displayed automatically and without direct user instruction to be displayed.

10. The method of claim 9, further comprising, in response to user instruction, redisplaying the table of data as the plurality of rows and the plurality of columns such that the values of the result records for each field that was filtered and not previously displayed are again not displayed.

11. A system comprising:
one or more processors;
a computer-readable medium to store a plurality of records, each record having one or more values for a plurality of fields, the fields dynamically dividable into one or more displayed fields and one or more non-displayed fields, the values of each record being displayed for the displayed fields and not displayed for the non-displayed fields; and,
a computer program executed by the processors to filter the records by one or more selected values for each of one or more filter fields to yield one or more result records, and to display the result records, including automatically displaying the values of each result record for each filter field, regardless whether the filter field is one of the displayed fields or one of the non-displayed fields.

12. The system of claim 11, wherein the computer program is to display the values of each result record for each filter field where a number of the selected values for the filter field that is one of the non-displayed fields is greater than one.

13. The system of claim 11, where the computer program is further to redisplay the result records without displaying the values of each result record for each filter field that is one of the non-displayed fields, in response to user instruction.

14. The system of claim 13, wherein the computer-readable medium is further to store:
a first timestamp for each filter field that is one of the non-displayed fields in conjunction with the values of each result record being displayed.for the filter field; and,
a second timestamp in conjunction with the user instruction,
wherein the computer program is to redisplay the result records without displaying the values of each result record for each filter field that is one of the non-displayed fields where the first timestamp for the filter field occurs before the second timestamp.

15. The system of claim 13, wherein the computer-readable medium is further to store a flag for each non-displayed field, the flag for each filter field that is one of the non-displayed fields being set in conjunction with the values of each result record being displayed for the filter field, and the flag being cleared in conjunction with the result records being redisplayed without displaying the values of each result record for the filter field.

16. The system of claim 11, where the computer program is further to redisplay the result records without displaying the values of each result record for each filter field that is one of the non-displayed fields, based on at least one of a timestamp for the filter field and a flag for the filter field.

17. A system comprising:
means for storing a plurality of records, each record having one or more values for a plurality of fields, the fields dynamically dividable into one or more displayed fields and one or more non-displayed fields, the values of each record being displayed for the displayed fields and not displayed for the non-displayed fields; and,
means for filtering the records by one or more selected values for each of one or more filter fields to yield one or more result records, and for displaying the result records, including automatically displaying the values of each result record for each filter field, regardless whether the filter field is one of the displayed fields or one of the non-displayed fields.

18. The system of claim 17, wherein the means for filtering and for displaying is further for redisplaying the result records without displaying the values of each result record for each filter field that is one of the non-displayed fields.

19. The system of claim 18, wherein the means for filtering, for displaying, and for redisplaying is to redisplay the result records without displaying the values of each result record for each filter field that is one of the non-displayed fields, based on at least one of a timestamp for the filter field and a flag for the filter field.

20. A computer-readable medium having a computer program stored thereon comprising:
a first computer program part to display a table of data as a plurality of rows and a plurality of columns, the table of data having a plurality of records, each record having one or more values for each of at least one of a plurality of fields of the table of data, each row corresponding to a record of the table of data and each column corresponding to a field of the table of data, the fields greater in number than the columns such that at least one of the fields is not displayed;
a second computer program part to filter the table of data by one or more selected values for each of at least one of the fields that are not displayed, to yield one or more result records; and,
a third computer program part to redisplay the table of data as the rows and the columns such that the values of the result records for each field that was filtered are now displayed automatically and without direct user instruction to be displayed.

21. The computer-readable medium of claim 20, the computer program further comprising a fourth computer program part to redisplay the table of data as the rows and the columns such that the values of the result records for each field that was filtered and not previously displayed are again not displayed.
